(19) United States
(12) Patent Application Publication
(10) Pub. No.: US 2022/0181920 A1
(43) Pub. Date: Jun. 9, 2022

(54) END WINDING FLUX MOTOR

(71) Applicant: NOTTINGHAM ELECTRIFICATION CENTRE, Ningbo (CN)

(72) Inventors: He ZHANG, Ningbo (CN); Bowen SHI, Ningbo (CN); Christopher Gerada, Ningbo (CN); Jing LI, Ningbo (CN); Xiaochen ZHANG, Ningbo (CN)

(21) Appl. No.: 17/334,968

(22) Filed: May 31, 2021

(30) Foreign Application Priority Data
Dec. 9, 2020 (CN) 202011429240.5

(51) Int. Cl. H02K 1/14; H02K 7/00; H02K 1/02

(52) U.S. Cl. CPC H02K 1/14; H02K 1/02; H02K 7/003

(57) ABSTRACT

An end winding flux motor is provided, which is axially connected at an end of a traditional motor, the traditional motor comprises a stator and a rotor, and the rotor is inserted into the stator; a stator winding is mounted on the stator and includes an end winding protruding from an end of the stator, and the end winding flux motor includes an end extension piece, a rotor yoke and a magnetic steel; one end of the end extension piece is connected with the stator. The winding of the motor is utilized in this way in the present disclosure to increase a power density of the motor, improve a heat dissipation capability of the end winding, and increase a “torque-current ratio” of the motor.

### CROSS-REFERENCE TO RELATED APPLICATIONS

This application claims priority to Chinese Patent Application No. 202011429240.5 with a filing date of Dec. 9, 2020. The content of the aforementioned application, including any intervening amendments thereto, are incorporated herein by reference.

### TECHNICAL FIELD

The present invention relates to the field of motors, and in particular to an end winding flux motor.

### BACKGROUND

A motor is an electromagnetic device that realizes conversion or transmission of electric energy according to the electromagnetic induction law. A rotor of the motor is generally sleeved in a stator, and electromagnetic conversion is realized by relative rotation of the stator and the rotor. Generally, a cylindrical stator is wound with a stator winding; a cylindrical rotor is sleeved in the stator with its length similar to that of the stator; a portion of the stator winding at an end of the stator is referred to as an end winding. The end winding protrudes from the end of the stator and is presented in a bending shape. The end winding does not play any role in a main magnetic field, and will cause additional copper loss and leakage inductance, resulting in waste of working efficiency. At the same time, a working temperature of the end winding during work is higher than that of its body.

### SUMMARY

In view of the above technical problem, the present invention provides an end winding flux motor. An end winding of the motor is utilized in this way to increase a power density of the motor, improve a heat dissipation capability of the end winding, and increase a “torque-current ratio” of the motor.

To solve the above technical problem, the present invention adopts the following technical solution. An end winding flux motor is provided, which is axially connected at an end of a traditional motor, the traditional motor comprises a stator and a rotor, and the rotor is inserted into the stator; a stator winding is mounted on the stator and comprises an end winding protruding from an end of the stator, and the end winding flux motor comprises an end extension piece, a rotor yoke and a magnetic steel; one end of the end extension piece is connected with the stator, and the end winding is wound on the end extension piece, so that the end extension piece and the stator share one winding; the rotor yoke is disposed at an end of the end extension piece away from the stator, and the rotor yoke and the rotor are connected with a same motor shaft; the magnetic steel is disposed between the end extension piece and the rotor yoke and connected with the rotor yoke, and a gap is reserved between the magnetic steel and the end extension piece.

By adopting the above structure, the structure of the present invention has the following advantages compared with the prior art.

For the end winding flux motor, the end winding flux motor may be taken as an extension of a traditional motor, the end winding flux is taken as a new stator, the end winding is taken as a new stator winding, the rotor yoke is taken as a new rotor, and the magnetic steel is taken as a new rotor magnetic steel. Therefore, each group of end winding flux-magnetic steel-rotor yoke-magnetic steel-end winding flux forms a magnetic circuit in one motor, entirely forming a new motor. Thus, the end winding which is not fully utilized in the traditional motor is fully utilized to increase the power density of the motor and increase the torque-current ratio of the motor.

In an improvement, a through hole or opening is disposed at an end of the end extension piece close to the stator, the end winding is wound on the end extension piece through the through hole or opening, and one end of the end extension piece protruding out of the stator is higher than a height that the end winding protrudes from the stator. This improved structure will be more compact and sturdier after the end winding and the end extension piece are connected, thus making performance more stable.

In an embodiment, the end extension piece comprises several L-shaped teeth and a magnetic conducting ring. The several L-shaped teeth are arranged circumferentially and uniformly along the stator, the end winding is wound in a gap formed by every two adjacent L-shaped teeth, a horizontal segment of the L-shaped tooth is radially inserted into the end winding, and a vertical segment of the L-shaped tooth surrounds an outer side of the end winding. The magnetic conducting ring is sleeved on the rotor and flushed with the horizontal segments of the L-shaped teeth.

In a further improvement, a protrusion extending toward a center axis of the rotor is disposed at an end of the L-shaped tooth away from the stator, and the magnetic steel is disposed between the protrusions and the rotor yoke. The protrusion disposed in this improved structure may enable the L-shaped tooth to exactly face a larger area of magnetic steel to conduct more magnetic induction lines so as to achieve reasonable distribution of a magnetic circuit. Further, the protrusion can also reduce magnetic force leakage of the end winding.

Preferably, the magnetic steel comprises several fan-shaped annular magnetic blocks, and the several magnetic blocks are circumferentially arranged around an axis direction of the stator to form an annular structure.

In a further improvement, a ring-shaped magnetic isolation layer is disposed between an end of the end extension piece close to the stator and an end face of the stator and between the magnetic conducting ring and an end face of the rotor respectively. The magnetic isolation layer disposed in this improved structure may reduce magnetic flux leakage and keep a stable magnetic force.

In another embodiment, the end extension piece comprises several U-shaped teeth arranged circumferentially and uniformly along the stator. A horizontal bottom side of the U-shaped tooth is connected at an end of the stator along a radial direction of the stator, and two vertical sides of the U-shaped tooth are disposed along an axial direction of the stator. The end winding is wound in a gap formed by every two adjacent U-shaped teeth.

Preferably, the magnetic steel comprises two magnetic rings corresponding to ends of two vertical sides of the U-shaped teeth respectively, each of the magnetic rings comprises several fan-shaped annular magnetic blocks circumferentially arranged around the axis direction of the stator.

In a further improvement, a ring-shaped magnetic isolation layer is disposed between an end of the end extension piece close to the stator and the stator.

In a further improvement, each of the fan-shaped annular magnetic blocks comprises a plurality of small magnets which are attached together sequentially in layers along a radial direction of the magnetic block, and every two adjacent small magnets are staggeredly disposed at an equal angle in the same direction circumferentially.

Corresponding technical effects achieved by the above specific improved structure will be described in detail in specific embodiments.

### BRIEF DESCRIPTION OF THE DRAWINGS

FIG. 1 is a structural schematic diagram of an end winding flux motor according to a first embodiment of the present invention.

FIG. 2 is another structural schematic diagram of an end winding flux motor according to a first embodiment of the present invention.

FIG. 3 is a structural diagram of an L-shaped tooth in an end winding flux motor according to an embodiment of the present invention.

FIG. 4 is a structural schematic diagram of an end winding flux motor according to a second embodiment of the present invention.

FIG. 5 is a schematic diagram of a sectional structure of an end winding flux motor according to a first embodiment of the present invention.

FIG. 6 is a schematic diagram of a sectional structure of an end winding flux motor according to a second embodiment of the present invention.

FIG. 7 is a schematic diagram of a skewed structure of a small magnet of a fan-shaped annular magnetic block according to the present invention.

FIG. 8 is a front view of a skewed structure of a small magnet of a fan-shaped annular magnetic block according to the present invention.

FIG. 9 is a relationship diagram of a cogging torque and a small magnet skewing angle of an end winding flux motor according to a third embodiment of the present invention.

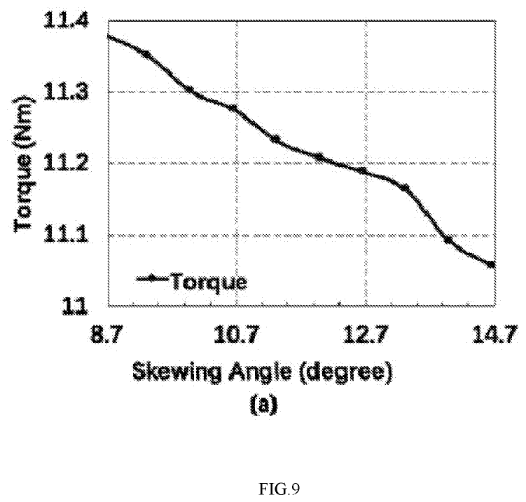

FIG. 10 is a relationship diagram of a torque ripple and a small magnet skewing angle of an end winding flux motor according to a third embodiment of the present invention.

FIG. 11 is a relationship diagram of a voltage waveform and a skewing angle of a small magnet according to a third embodiment of the present invention.

Numerals of the drawings are described as follows: 01-traditional motor; 1-stator, 2-end winding, 3a-U-shaped tooth, 3b-L-shaped tooth, 4-rotor yoke, 5-magnetic steel, 5.1-fan-shaped annular magnetic block, 5.1.1-small magnet, 6-magnetic conducting ring, 7-rotor, 8-protrusion, and 9-magnetic isolation layer.

### EMBODIMENTS

The present invention is further described below in combination with accompanying drawings and specific embodiments.

In the descriptions of the present invention, it is understood that orientations or positional relationships indicated by the terms such as “center axis”, “end”, “end face” and “bottom side” are orientations or positional relationships shown based on the drawings, and are only used for ease of descriptions of the present invention and simplification of the descriptions rather than indicate or imply that the indicated devices or elements must have a particular orientation, or be constructed or operated in a particular orientation. Therefore, such terms shall not be understood as limiting of the present invention.

In the descriptions of the present invention, it is to be noted that unless otherwise clearly stated or defined, the term “connect” shall be understood in a broad sense, for example, may be fixed connection, or detachable connection, or formed into one piece; or may be mechanical connection, or electrical connection; or direct connection or indirect connection through an intermediate medium, or may be internal communication between two elements. Those of ordinary skill in the art may understand the specific meanings of the above terms in the present invention according to actual situations.

### Basic Embodiment

The present invention discloses an end winding flux motor that is axially connected to an end of a traditional motor 01. Further, the end winding flux motor shares one motor shaft with the traditional motor 01, so that the traditional motor 01 and the end winding flux motor entirely form a new motor, thereby improving the performance of the motor without adding an additional winding.

In this structure, the traditional motor 01 comprises a stator 1 and a rotor 7 inserted into the stator 1; a stator winding is mounted on the stator 1, the stator winding comprises an end winding 2 which is a portion of the entire stator winding protruding from an end of the stator 1.

Specifically, the end winding flux motor comprises an end extension piece, a rotor yoke 4 and a magnetic steel 5; one end of the end extension piece is connected with the stator 1, where the end extension piece and the stator may be connected by bonding, riveting or bolting connection as long as one end of the end extension piece and the end of the stator 1 can be fixedly connected together. Furthermore, the end winding 2 is wound on the end extension piece, so that the end extension piece and the stator 1 share one winding without adding a new winding, simplifying the structure. The rotor yoke 4 is disposed at an end of the end extension piece away from the stator 1, and the rotor yoke 4 and the rotor 7 are connected with a same motor shaft 02; the magnetic steel 5 is disposed between the end extension piece and the rotor yoke 4 and connected with the rotor yoke 4, and a gap is reserved between the magnetic steel 5 and the end extension piece. During operation, the rotor yoke 4 connected with the motor shaft drives the magnetic steel 5 to rotate relative to the end extension piece, thereby realizing electromagnetic conversion.

In the above structure, the end winding flux motor may be taken as an extension of the traditional motor 01, the end winding flux is taken as a new stator, the end winding is taken as a new stator winding, the rotor yoke is taken as a new rotor, and the magnetic steel is taken as a new rotor magnetic steel. Each group of end winding flux-magnetic steel-rotor yoke-magnetic steel-end winding flux forms a magnetic circuit in one motor, entirely forming a new motor. Thus, the end winding which is not fully utilized in the traditional motor is fully utilized, so as to increase the power density of the motor and increase the torque-current ratio of the motor.

Further, in the above structure, a through hole or opening (not shown) is disposed at an end of the end extension piece close to the stator 1, the end winding 2 is wound on the end extension piece through the through hole or opening, and an end of the end extension piece protruding out of the stator is higher than a height that the end winding 2 protrudes from the stator 1. Therefore, the limiting stability after the end winding 2 is wound through the end extension piece is ensured.

When the through hole is disposed on the end extension piece and the stator winding is wound, the end winding is run through the through hole of the end extension piece and then wound back, so that the end winding and the end extension piece are connected integrally.

When the opening is disposed on the end extension piece and the stator winding is wound, the end winding is wound in the opening of the end extension piece in a limited manner to ensure positioning stability of the two structures.

The term “end extension piece” herein refers to a portion extending from the end of the stator 1 of the traditional motor to hold the end winding 2. The shape of the end extension piece is not particularly specified, but is required to satisfy the following several conditions: 1. a length along an axial direction of the stator 1 is greater than a height that the end winding 2 protrudes from the stator 1; 2. the end extension piece can participate in forming a magnetic circuit, for example, the end extension piece forms the magnetic circuit together with the magnetic steel 5 and the rotor yoke 4. In addition, the end extension piece is required to have good magnetic conductivity. Persons skilled in the art should understand that the specific magnetic conductivity may be selected according to selection criteria of magnetic conductivity characteristics of the stator and the rotor in the motor. The “magnetic conducting ring” herein refers to a ring made of materials containing a high-magnetic-permeability material, such as steel, silicon steel and R4K-R15K high-magnetic-permeability material.

### Embodiment 1

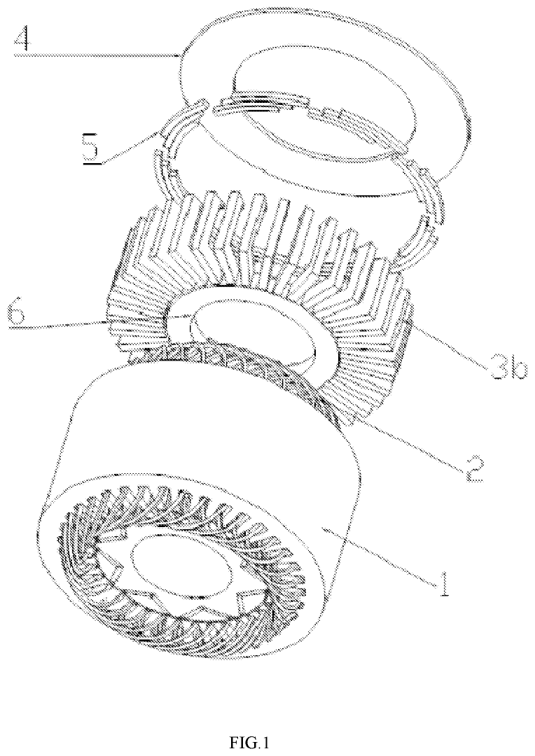

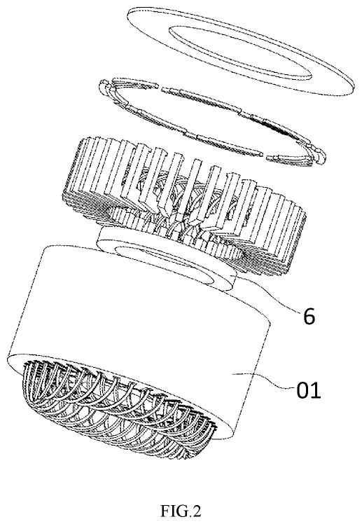

As shown in FIGS. 1, 2 and 5, based on the basic embodiment, the structure of the end extension piece is described in detail in this embodiment. Specifically, the end extension piece comprises several L-shaped teeth 3b and a magnetic conducting ring 6; several L-shaped teeth 3b are arranged circumferentially and uniformly along the stator 1, and the end winding 2 is wound in a gap formed by every two adjacent L-shaped teeth 3b, a horizontal segment of the L-shaped tooth 3b is radially inserted into the end winding 2, and a vertical segment of the L-shaped tooth 3b surrounds an outer side of the end winding 2; the magnetic conducting ring 6 is sleeved on the rotor and flushed with the horizontal segments of the L-shaped teeth 3b.

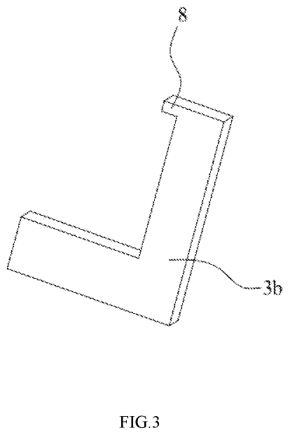

Specifically, as shown in FIG. 3, a protrusion 8 extending toward a center axis of the rotor 7 is disposed at an end of each L-shaped tooth 3b away from the stator 1 respectively; specifically, the protrusion 8 and the L-shaped tooth 3b are of an integral structure, and the magnetic steel 5 is disposed between the protrusions 8 and the rotor yoke 4.

The magnetic steel 5 comprises several fan-shaped annular magnetic blocks 5.1 circumferentially arranged along an axial direction of the stator 1 to form an annular structure. A ring-shaped magnetic isolation layer 9 is disposed between an end of the end extension piece close to the stator 1 and an end face of the stator 1 and between the magnetic conducting ring 6 and an end face of the rotor 7 respectively to reduce occurrence of magnetic flux leakage and improve the stability of a magnetic force. Specifically, the magnetic isolation layer in this structure comprises two ring-shaped magnetic isolation rings disposed between the horizontal segment of the L-shaped tooth 3b and the end face of the stator 1 and between the magnetic conducting ring 6 and the end face of the rotor 7 respectively so as to fully reduce the leakage of the magnetic force and maintain the stability of the magnetic circuit. More specifically, in this structure, every two adjacent fan-shaped annular magnetic blocks 5.1 are opposite in magnetic pole.

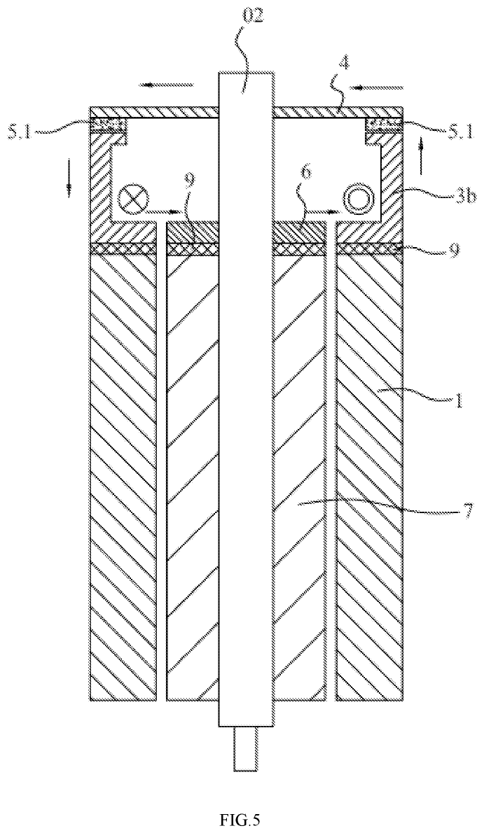

The working principle is as follows: in the end winding flux motor, the end winding flux motor may be taken as an extension of the traditional motor, the L-shaped teeth 3b are taken as a new stator, the end winding 2 is taken as a new stator winding, the rotor yoke 4 is taken as a new rotor, and the magnetic steel 5 is taken as a new rotor magnetic steel. With reference to a direction indicated by an arrow in FIG. 5, a specific magnetic circuit path is as follows: the path starts from one of the magnetic blocks 5.1, runs through the rotor yoke 4 to reach another magnetic block 5.1 adjacent to the magnetic block 5.1, and then reaches the magnetic conducting ring 6 through one L-shaped stator, and then returns to another L-shaped stator adjacent to the L-shaped stator, and finally returns to the magnetic steel 5, so as to form a closed magnetic circuit, thereby enabling the overall structure to form a new motor. Further, the end winding 2 which is not fully utilized in the traditional motor is fully utilized in this structure to increase the power density of the motor and increase the torque-current ratio of the motor.

### Embodiment 2

This embodiment is different from the embodiment 1 only in that each fan-shaped annular magnetic block 5.1 is divided into a plurality of small magnets 5.1.1 attached together sequentially in layers along a radial direction of the magnetic block 5.1, and every two adjacent small magnets 5.1.1 are staggeredly disposed at an equal angle in the same direction circumferentially.

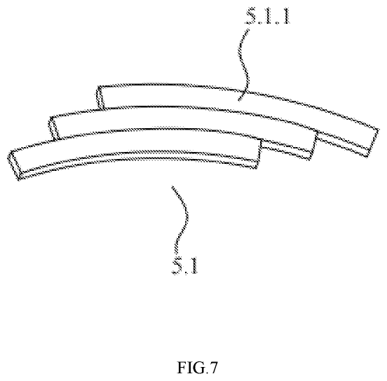

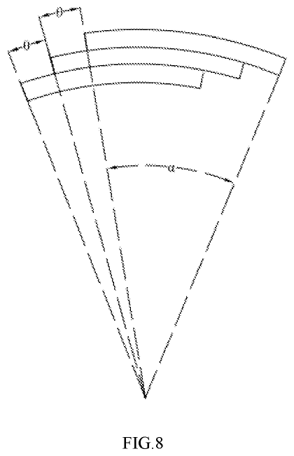

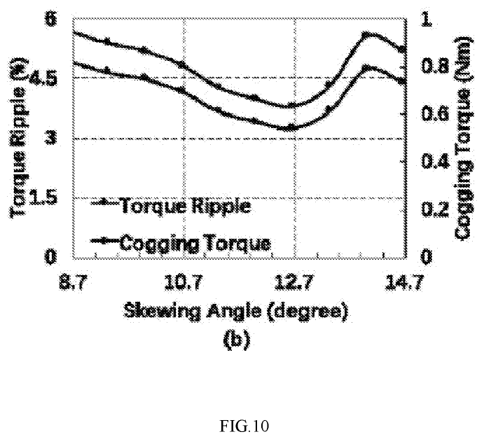

Specifically, in this embodiment, for example, a simulation analysis is performed by taking a 36-slot 8-pole V-shaped internal magnet as a motor model with a rated speed of 2800 rpm and a rated torque of 120 Nm. Further, in this structure, each fan-shaped annular magnetic block 5.1 comprises three small magnets 5.1.1, and every two adjacent small magnets 5.1.1 are designed to be skewed at a certain angle. Specifically, as shown in FIGS. 7 and 8, a span angle of each small magnet 5.1.1 is a, and a mechanical skewing angle of two adjacent small magnets 5.1.1 is θ. It is found through the simulation test that, when the mechanical skewing angle θ of any two adjacent small magnets 5.1.1 is 12.67°, cogging torque ripples all reach an optimal value, as shown in FIG. 10.

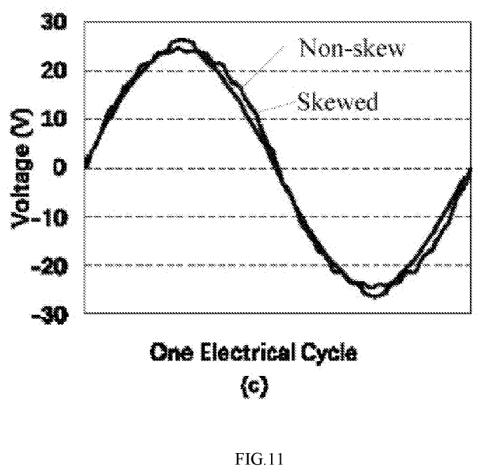

In addition, as shown in FIG. 11, after skew is increased among three small magnets 5.1.1, a more complete sinusoidal voltage waveform can be obtained. In summary, after every two adjacent small magnets 5.1.1 are staggeredly disposed at an equal angle in the same direction circumferentially, the end winding flux motor can produce better performance.

### Embodiment 3

Based on Embodiment 1, another structure of the end extension piece is described below.

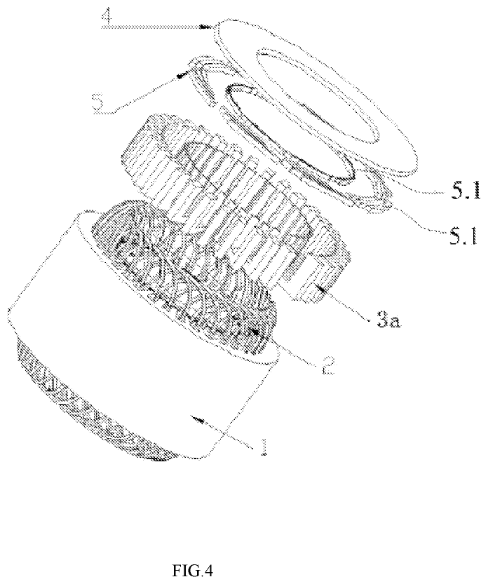

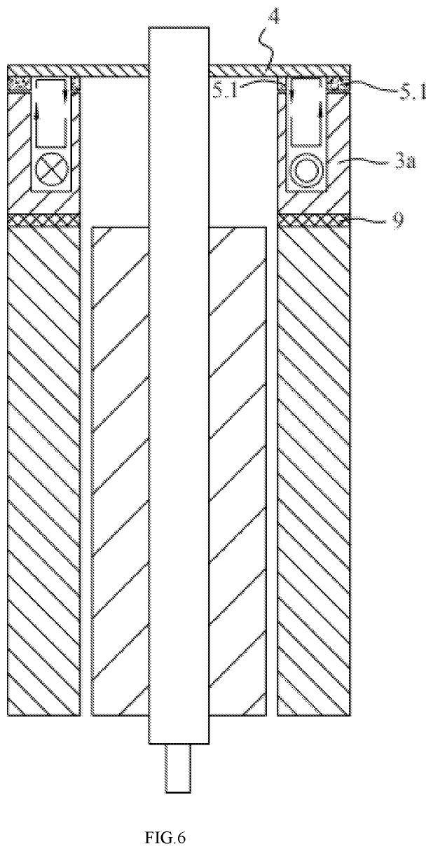

As shown in FIGS. 4 and 6, the end extension piece comprises several U-shaped teeth 3a arranged circumferentially and uniformly along the stator 1. A horizontal bottom side of the U-shaped tooth 3a is connected to the end of the stator 1 along a radial direction of the stator 1, and two vertical sides of the U-shaped tooth 3a are disposed along an axial direction of the stator 1; the end winding 2 is wound in a gap formed by every two adjacent U-shaped teeth 3a.

Similarly, in this structure, the magnetic steel 5 comprises two magnetic rings corresponding to ends of two vertical sides of the U-shaped teeth 3a respectively, and each magnetic ring comprises several fan-shaped annular magnetic blocks 5.1 circumferentially arranged around an axial direction of the stator 1. More specifically, every two adjacent fan-shaped annular magnetic blocks 5.1 are opposite in magnetic pole, and every two fan-shaped annular magnetic blocks 5.1 radially opposed are also opposite in magnetic pole.

In this structure, a ring-shaped magnetic isolation layer 9 is disposed between an end of the end extension piece close to the stator 1 and the stator 1. Specifically, the magnetic isolation layer 9 is disposed between the horizontal bottom sides of the U-shaped teeth 3a and the end of the stator 1.

In addition, it can also be seen from this structure that the side of the U-shaped tooth 3a away from an axis of the stator 1 is thicker than the side of the U-shaped tooth 3a close to the axis of the stator 1 to realize reasonable distribution of the magnetic circuit and achieve the effect of device safety.

The working principle is as follows: the working principle in this embodiment is substantially same as that of embodiment 1 except that the path of the magnetic circuit is different. Specifically, with reference to the direction indicated by an arrow shown in FIG. 6, a path of a primary magnetic circuit in this embodiment is as follows: the parth starts from the radially external magnetic ring (an external fan-shaped annular magnetic block 5.1) and runs through the rotor yoke 4 to reach the internal magnetic ring (an internal fan-shaped annular magnetic block 5.1), and then passes through the U-shaped tooth 3a, and finally returns to the external magnetic ring (an external fan-shaped annular magnetic block 5.1), so as to form a closed magnetic circuit. In this embodiment, each U-shaped tooth 3a can form a magnetic circuit.

In this structure, in addition to the above path of the primary magnetic circuit, there is also a secondary magnetic circuit. That is, in addition to that the magnetic force reaches a corresponding internal fan-shaped annular magnetic block 5.1 from each external starting fan-shaped annular magnetic block 5.1, part of the magnetic force may also be transmitted toward its adjacent external fan-shaped annular magnetic block 5.1 to form another secondary magnetic circuit path. In this structure, the path of the primary magnetic circuit is mainly described and thus a further description to the secondary magnetic circuit will not be made herein.

The design of the U-shaped teeth 3a also ensures heat dissipation of the end winding 2.

### Embodiment 4

Based on any one of embodiments 1-3, a corresponding winding flux motor is disposed at both ends of the traditional motor 01 respectively with other structures being substantially same, so as to obtain a more stable novel motor.

The working principle is as follows: the original rotor, the rotor magnetic steel and the magnetic steel 5 and the rotor yoke 4 form a new rotor which is fixed on the motor shaft, and the original stator, the stator winding and the end extension piece together form a new stator, so as to work as a traditional motor.

Compared with the prior art, these embodiments have the following beneficial effects. The novel motor, i.e., “the end winding flux motor” is proposed, and the motor and the traditional radial flux motor are electromagnetically and mechanically connected to share one winding and one shaft. In this way, the end winding of the motor is used to increase the power density of the motor, improve the heat dissipation capability of the end winding, and increase the “torque-current ratio” of the motor.

The forgoing descriptions are merely made to optimal embodiments of the present invention rather than limit the claims. The present invention is not limited to the above embodiments, and a specific structure thereof may be changed. Any changes made within the scope of protection of the independent claims of the present invention shall all fall within the scope of protection of the present invention.

1. An end winding flux motor, which is axially connected at an end of a traditional motor (01), the traditional motor (01) comprises a stator (1) and a rotor (7), and the rotor (7) is inserted into the stator (1); a stator winding is mounted on the stator (1) and includes an end winding (2) protruding from an end of the stator (1), wherein the end winding flux motor includes an end extension piece, a rotor yoke (4) and a magnetic steel (5); one end of the end extension piece is connected with the stator (1), and the end winding (2) is wound on the end extension piece, so that the end extension piece and the stator (1) share one winding; the rotor yoke (4) is disposed at an end of the end extension piece away from the stator (1), and the rotor yoke (4) and the rotor (7) are connected with a same motor shaft (02); the magnetic steel (5) is disposed between the end extension piece and the rotor yoke (4) and connected with the rotor yoke (4), and a gap is reserved between the magnetic steel (5) and the end extension piece.

2. The end winding flux motor of claim 1, wherein a through hole or opening is disposed at an end of the end extension piece close to the stator (1), the end winding (2) is wound on the end extension piece through the through hole or opening, and one end of the end extension piece protruding out of the stator (1) is higher than a height that the end winding (2) protrudes from the stator (1).

3. The end winding flux motor of claim 1, wherein the end extension piece comprises several L-shaped teeth (3b) and a magnetic conducting ring (6). The several L-shaped teeth (3b) are arranged circumferentially and uniformly along the stator (1), the end winding (2) is wound in a gap formed by every two adjacent L-shaped teeth (3b), a horizontal segment of the L-shaped tooth (3b) is radially inserted into the end winding (2), and a vertical segment of the L-shaped tooth (3b) surrounds an outer side of the end winding (2); the magnetic conducting ring (6) is sleeved on the rotor (7) and flushed with the horizontal segments of the L-shaped teeth (3b).

4. The end winding flux motor of claim 3, wherein a protrusion (8) extending toward a center axis of the rotor (7) is disposed at an end of the L-shaped tooth (3b) away from the stator (1), and the magnetic steel (5) is disposed between the protrusions (8) and the rotor yoke (4).

5. The end winding flux motor of claim 4, wherein the magnetic steel (5) comprises several fan-shaped annular magnetic blocks (5.1), and the several magnetic blocks (5.1) are circumferentially arranged around an axis direction of the stator (1) to form an annular structure.

6. The end winding flux motor of claim 3, wherein a ring-shaped magnetic isolation layer (9) is disposed between an end of the end extension piece close to the stator (1) and an end face of the stator (1) and between the magnetic conducting ring (6) and an end face of the rotor (7) respectively.

7. The end winding flux motor of claim 1, wherein the end extension piece comprises several U-shaped teeth (3a) arranged circumferentially and uniformly along the stator (1); a horizontal bottom side of the U-shaped tooth (3a) is connected at an end of the stator (1) along a radial direction of the stator (1), and two vertical sides of the U-shaped tooth (3a) are disposed along an axial direction of the stator (1); the end winding (2) is wound in a gap formed by every two adjacent U-shaped teeth (3a).

8. The end winding flux motor of claim 6, wherein the magnetic steel (5) comprises two magnetic rings corresponding to ends of two vertical sides of the U-shaped teeth (3a) respectively, each of the magnetic rings comprises several fan-shaped annular magnetic blocks (5.1) circumferentially arranged around the axis direction of the stator (1).

9. The end winding flux motor of claim 1, wherein a ring-shaped magnetic isolation layer (9) is disposed between an end of the end extension piece close to the stator (1) and the stator (1).

10. The end winding flux motor of claim 5, wherein each of the fan-shaped annular magnetic blocks (5.1) comprises a plurality of small magnets (5.1.1) which are attached together sequentially in layers along a radial direction of the magnetic block (5.1), and every two adjacent small magnets (5.1.1) are staggeredly disposed at an equal angle in the same direction circumferentially.

11. The end winding flux motor of claim 8, wherein each of the fan-shaped annular magnetic blocks (5.1) comprises a plurality of small magnets (5.1.1) which are attached together sequentially in layers along a radial direction of the magnetic block (5.1), and every two adjacent small magnets (5.1.1) are staggeredly disposed at an equal angle in the same direction circumferentially.
